(19) United States
(12) Patent Application Publication
(10) Pub. No.: US 2025/0198879 A1
(43) Pub. Date: Jun. 19, 2025

(54) Explosion-Proof-Enivironment Bench Top Heating Test Apparatus for Performance Testing of Safety Valve

(71) Applicant: KOREA GAS SAFETY CORPORATION, Chungcheongbuk-do (KR)

(72) Inventors: Ho Byung JUN, Gangwon-do (KR); Dong Hoon LEE, Gangwon-do (KR); Min Hyung SEO, Gangwon-do (KR); Hee Joon SHIM, Gangwon-do (KR); Chan Ho JEONG, Gangwon-do (KR)

(21) Appl. No.: 18/849,451

(22) PCT Filed: Mar. 21, 2023
(86) PCT No.: PCT/KR2023/003726

§ 371 Date: Sep. 20, 2024

(30) Foreign Application Priority Data
Nov. 30, 2022 (KR) 10-2022-0165087

(51) Int. Cl. G01M 13/003; F27B 17/02; F27D 21/00

(52) U.S. Cl. CPC G01M 13/003; F27B 17/02; F27D 21/00; F27D 2021/0071

(57) ABSTRACT

A heating test apparatus, according to one embodiment of the present invention, for testing the performance of a sample valve that opens when a predetermined temperature is reached comprises: an explosion-proof chamber having an explosion-proof compartment, which is a space opened or closed through an explosion-proof door, formed therein; a sample-holding module, which is provided in the explosion-proof compartment, holds the sample valve in the air, and supplies gas of a predetermined pressure to the sample valve; a bench top module, which is provided in the explosion-proof compartment and moves a test box having a heating furnace therein; and a control unit for controlling the bench top module on the basis of the position of the sample valve and the test box such that the sample valve is accommodated in the heating furnace.

### TECHNICAL FIELD

The present disclosure relates to an explosion-proof-environment bench top heating test apparatus for performance testing of a safety valve, and more particularly, to a test apparatus that prevents an experimenter from being exposed to danger and prevents safety incidents when testing performance of a safety valve provided to open at a predetermined temperature to discharge high-pressure hydrogen.

### BACKGROUND ART

Energy may be expressed in various forms, including positional energy, kinetic energy, thermal energy, electrical energy, chemical energy, and nuclear energy.

A traditional way of producing energy is using fossil fuels.

Fossil fuels refer to resources buried underground, such as coal, oil, natural gas, oil shale, tar sands, and the like, which are derived from animal and plant fossils.

Most of energy used by humanity is obtained from non-cyclical depletable resources, such as fossil fuels and uranium resources. However, non-cyclical depletable resources, such as fossil fuels and uranium resources, not only have limited reserves, but also have the problem of causing global warming and air pollution.

Therefore, the need for energy sources that may replace depleted fuels and energy sources that may protect the earth and the environment is increasing.

Accordingly, research on renewable energy is also actively underway. Renewable energy often refers to resources that may be replenished repeatedly, such as sun, wind, rivers, hot springs, tides, and biofuels.

Even in the automotive field in which oil, which is a kind of fossil fuel, was heavily used, research on resources that may replace oil is actively underway.

Recently, hydrogen fuel, which is a new renewable energy source, has been attracting attention as an automobile fuel that may replace oil.

Hydrogen fuel produces electrical energy using electrochemical cells. Electric vehicles using hydrogen fuel have low noise when driving, have excellent acceleration performance, and are eco-friendly because they do not produce environmental pollutants.

Hydrogen fuel also has the advantage of requiring a relatively short charging time.

However, hydrogen, which is a gaseous fuel, may be easily lost during storing and charging processes, and may cause fires or explosions under specific conditions.

In order to widely utilize hydrogen fuel, it is necessary to develop various technologies related to transportation, storage, and charging of hydrogen fuel.

Korean Patent Publication No. 10-2007-0036094 (hereinafter referred as “the related art”) discloses “safety valve test apparatus”.

The related art relates to an apparatus for testing a safety valve, as a safety device, which is automatically operated to protect a facility when excessive pressure occurs in machines or piping lines installed in a plant, such as an oil refinery, a petrochemical plant, or a power plant. Although the related art may test safety valves having various sizes, it is insufficient to fully verify the performance of a safety valve as a device for storing, transporting, and supplying a special purpose fluid.

Therefore, it was necessary to propose a technology to solve the above problem.

### DISCLOSURE

### Technical Problem

It is an object of the present disclosure to solve a problem in the prior art in which there was a risk of safety incidents due to explosions and flying debris when ultra-high pressure gas was ejected.

It is another object of the present disclosure to solve a problem in the prior art in which it was difficult to verify the performance of a safety valve that stores or transports hydrogen fuel at ultra-high pressure and high temperature.

It is yet another object of the present disclosure to provide a prevention measure against explosions and fires that may occur during handling of high-temperature and high-pressure hydrogen fuel.

The objects of the present disclosure are not limited to the above-described objects, and other objects or purposes not mentioned herein will be clearly understood from the following description.

### Technical Solution

A heating test apparatus according to one embodiment of the present disclosure is a test apparatus for performance testing of a safety valve, which tests performance of a sample valve configured to open upon reaching a predetermined temperature, and includes an explosion-proof chamber having an explosion-proof compartment as a space opened or closed through an explosion-proof door, formed therein, a sample-holding module provided in the explosion-proof compartment and configured to hold the sample valve in air and supply gas of a predetermined pressure to the sample valve, a bench top module provided in the explosion-proof compartment and configured to move a test box having a heating furnace therein, and a controller configured to control the benchtop module based on positions of the sample valve and the test box so that the sample valve is accommodated in the heating furnace.

In the test apparatus according to one embodiment of the present disclosure, the sample valve may include a valve body connected to the sample-holding module, and a safety opening and closing unit provided on one side of the vehicle body and opened at a temperature of 110 degrees Celsius, the gas supplied to the sample valve through the sample-holding module may be hydrogen (H₂) pressurized to 700 MPa, and an internal pressure of the heating furnace may be heated to 600 degrees Celsius.

In the test apparatus according to one embodiment of the present disclosure, the sample-holding module may include a holding frame installed on a ceiling of the explosion-proof compartment to have a predetermined path, a sample tower coupled to the holding frame, moved along the holding frame, and configured such that the sample valve is coupled to the sample tower, and a fuel supply pipe configured to supply hydrogen fuel of a predetermined pressure to the sample valve.

In the test apparatus according to one embodiment of the present disclosure, the benchtop-module may include guide rails installed on a bottom of the explosion-proof compartment to have a predetermined path, a movable body coupled to the guide rails to be moved along the guide rails and configured such that the test box is coupled to an upper part of the movable body, and an elevating unit configured to raise and lower the test box from the movable body.

In the test apparatus according to one embodiment of the present disclosure, the test box may include an inlet connected to the heating furnace provided inside the test box and formed at a center of an upper surface of the test box, an entry end formed along an open perimeter of the inlet, and a precision detection sensor provided at the entry end and configured to detect the position of the sample valve located outside or inside the heating furnace and transmit a position of the entry end and the position of the sample valve to the controller.

In the test apparatus according to one embodiment of the present disclosure, the test box may further include a shutoff door configured to open or close the inlet, and the controller may open the shutoff door when the sample valve approaches the inlet by a predetermined distance or less.

In the test apparatus according to one embodiment of the present disclosure, the heating furnace may be provided as a spherical space formed inside the test box.

In the test apparatus according to one embodiment of the present disclosure, the test box may include a plurality of reinforcement parts formed at parts of a side wall of the heating furnace, configured to protrude inward to increase strength of the test box, and provided such that a horizontal cross-section of the heating furnace is point symmetrical with respect to a central point of the heating furnace, and fracture parts formed between the reinforcement parts on an inner surface of the heating furnace and configured to be at least partially destroyed when the heating furnace reaches a predetermined pressure.

In the test apparatus according to one embodiment of the present disclosure, each of the fracture parts may include a plurality of expansion walls formed along virtual straight lines drawn radially from the central point of the heating furnace, and a fracture wall formed of a thinner material than the reinforcement parts between the expansion walls and torn and destroyed when the heating furnace reaches the predetermined pressure.

### Advantageous Effects

According to the present disclosure, the risk of safety incidents is reduced during a testing process in which compressed hydrogen gas is temporarily ejected.

According to the present disclosure, the performance of a safety valve used in processes of storing, transporting, and charging hydrogen fuel may be tested in an environment similar to actual situations.

According to the present disclosure, it is possible to prevent explosions and fires that may occur when high-temperature and high-pressure hydrogen fuel is ejected.

The effects of the present disclosure are not limited to those mentioned above, and other effects not mentioned above will be clearly understood by those skilled in the art from the following description.

### DESCRIPTION OF DRAWINGS

FIG. 1 is a perspective view of a heating test apparatus according to one embodiment of the present disclosure.

FIG. 2 is a cross-sectional view of an explosion-proof chamber in the heating test apparatus according to one embodiment of the present disclosure.

FIG. 3 is a cross-sectional view of the explosion-proof chamber in the heating test apparatus according to one embodiment of the present disclosure, showing a state in which a benchtop module is moving.

FIG. 4 is a perspective view of a test box in the heating test apparatus according to one embodiment of the present disclosure.

FIG. 5 is a view showing an inlet and an entry end of the test box in the heating test apparatus according to one embodiment of the present disclosure.

FIG. 6 is a cross-sectional view taken along line A-A′ of FIG. 4.

FIG. 7 is a block diagram briefly showing some components provided in an explosion-proof compartment in the heating test apparatus according to one embodiment of the present disclosure.

FIG. 8 is a perspective view of a test box in a heating test apparatus according to another embodiment of the present disclosure.

### MODE FOR INVENTION

Hereinafter, appropriate embodiments of the present disclosure will be described. The embodiments of the present disclosure will be described in more detail with reference to the accompanying drawings. Like reference numerals refer to the same elements throughout the detailed description.

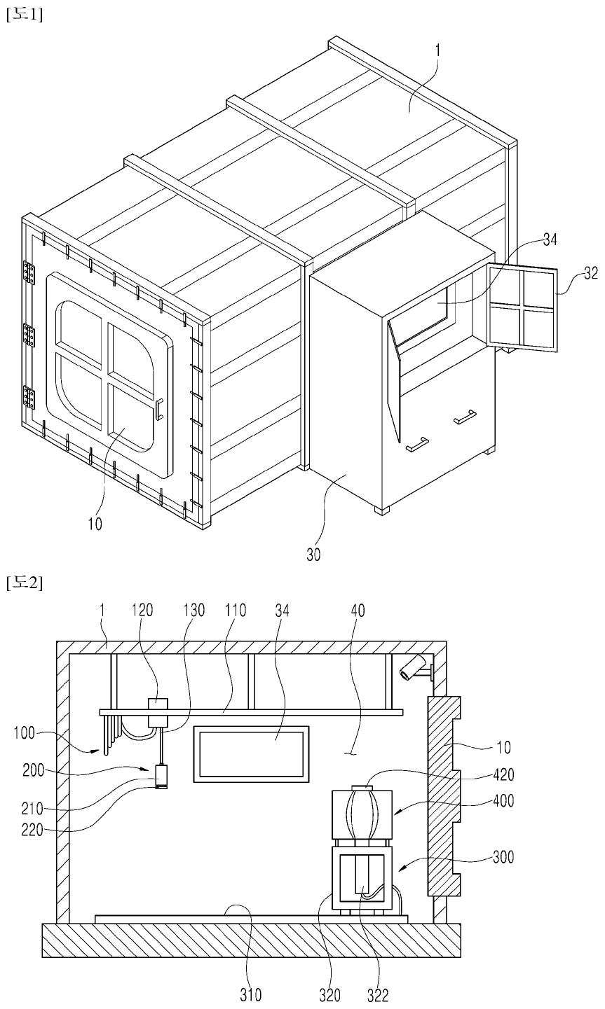

FIG. 1 is a perspective view of a heating test apparatus according to one embodiment of the present disclosure.

As shown in FIG. 1, the heating test apparatus according to one embodiment of the present disclosure may include an explosion-proof chamber 1 and a control booth 30.

The explosion-proof chamber 1 includes an explosion-proof compartment 40. The explosion-proof compartment 40 is a designated test space formed in the explosion-proof chamber 10.

The explosion-proof chamber 1 may further include an explosion-proof door 10, and the explosion-proof door 10 is provided at the entrance of the explosion-proof compartment 40 to open and close the explosion-proof compartment 40.

The explosion-proof compartment 40 may be adjusted so that the inside thereof has predetermined conditions. Further, if an explosion occurs in the explosion-proof compartment 40, the explosion-proof compartment 40 traps flames or fragments resulting from the explosion to safely protect the surroundings.

As shown in this figure, the explosion-proof chamber 1 is a structure provided with one surface to which the explosion-proof door 10 is coupled, and is formed of a material that may maintain robustness even in a high-temperature and high-pressure environment.

The explosion-proof chamber 1 may be provided with an observation window 34. The observation window 34 is formed of tempered glass or reinforced plastic, and may be transparent so that the explosion-proof compartment 40 may be observed from outside the explosion-proof chamber 1.

In addition, the control booth 30 may be further formed outside the explosion-proof chamber 1. The control booth 30 may include a main door 32 configured to open or close the observation window 34. Further, electronic devices or monitoring devices for conducting designated tests in the explosion-proof compartment 40 may be installed in the control booth 30.

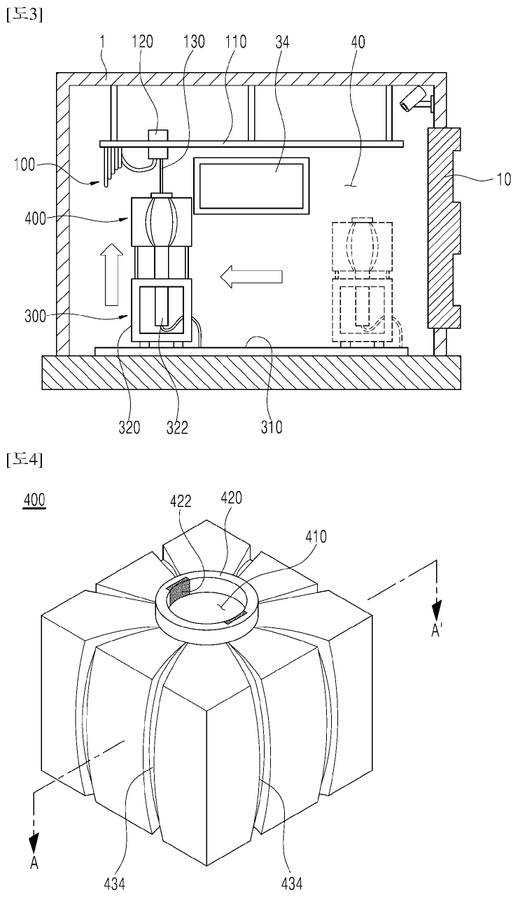

FIG. 2 is a cross-sectional view of the explosion-proof chamber 1 in the heating test apparatus according to one embodiment of the present disclosure, and FIG. 3 is a cross-sectional view of the explosion-proof chamber 1 in the heating test apparatus according to one embodiment of the present disclosure, showing a state in which a benchtop module 300 is moving.

As shown in FIGS. 2 and 3, the heating test apparatus according to one embodiment of the present disclosure further includes a sample-holding module 100, a sample valve 20, the benchtop module 300, a test box 400, and a controller 500.

The sample-holding module 100, the sample valve 20, the benchtop module 300, the test box 400, and the controller 500 are provided in the explosion-proof compartment 40 within the explosion-proof chamber 1.

The sample-holding module 100 includes a holding frame 110, a sample tower 120, and a fuel supply pipe 130. The sample-holding module 100 holds the sample valve 200 in the explosion-proof compartment 40.

Specifically, the sample-holding module 100 locates the sample valve 200 at a predetermined position within the internal space of the explosion-proof compartment 40. The sample-holding module 100 may move the position of the sample valve 200. Further, fuel gas of a predetermined pressure may be injected into the sample valve 200 through the sample-holding module 100.

The holding frame 110 may be formed on the ceiling of the explosion-proof compartment 40. The holding frame 110 may be formed of rails having a predetermined path.

The sample tower 120 moves along the holding fame 110. The sample tower 120 may be formed of a designated enclosure, and the sample valve 200 is suspended at the lower portion of the sample tower 120 while being connected to the fuel supply pipe 130.

Accordingly, the sample tower 120 may move along the holding frame 110 while the fuel supply pipe 130 and the sample valve 200 are coupled to the sample tower 120, and may adjust the hanging height of the sample valve 200.

These series of operations may be performed by manipulating an operation module provided in the control booth 30. This is an example, and the movement or height adjustment of the sample valve 200 may be performed automatically or manually in various types depending on the embodiment to which the present disclosure is applied.

The benchtop module 300 may include guide rails 310, a movable body 320, and an elevating unit 322. The test box 400 is coupled to the upper part of the benchtop module 300.

The guide rails 310 are provided on the bottom of the explosion-proof compartment 40 in the explosion-proof chamber 1. The guide rails 310 are formed to have a predetermined path, and, in one embodiment of the present disclosure, may be formed as two parallel rails, as shown in the figures.

The movable body 320 moves along the guide rails 310. The test box 400 is coupled to the movable body 320. The test box 400 moves together with movement of the movable body 320.

The movable body 320 includes the elevating unit 322. The elevating unit 322 raises or lowers the test box 400 coupled to the upper part of the movable body 320. In one embodiment of the present disclosure, the elevating unit 322 may be implemented as a multi-cylinder device having a length adjusted depending on the pressure of the internal space thereof.

As shown in FIG. 3, the sample-holding module 100 fixes the sample valve 20 by suspending the sample valve 200 in the air. Further, the sample-holding module 100 supplies fuel gas of the predetermined pressure to the sample valve 20.

The benchtop module 300 moves the test box 400 so that the test box 400 is located vertically below the sample valve 200. The test box 400 moved vertically below the sample valve 200 may be raised through the elevating unit 322, and as the test box 400 is raised, the sample valve 200 enters the test box 400 to be accommodated in the test box 400.

The sample-holding module 100, the benchtop module 300, and the test box 400 are controlled by the controller 500, and a detailed description thereof will be given later.

FIG. 4 is a perspective view of the test box 400 in the heating test apparatus according to one embodiment of the present disclosure.

As shown in FIG. 4, the test box 400 has a heating furnace 430 formed therein. An inlet 410 connected to the heating furnace 430 is formed in the upper surface of the test box 400.

The inlet 410 may be a circular opening. Further, an entry end 420 which protrudes upward from the upper surface of the test box 400 along the perimeter of the inlet 410 is provided.

The test box 400 has the appearance of a rectangular parallelepiped in which a square bottom surface, a top surface having the inlet 410 formed at the center thereof, and four side surfaces are combined.

The test box 400 may be provided with a plurality of fracture parts 434, which are grooves extending from the entry end 420 to the bottom surface of the test box 400. The fracture parts 434 are grooves sunken in the outer surfaces of the upper, side, and bottom surfaces of the test box 400, and the width of the fracture parts 434 is greatest at the center of each side surface, and decreases as they approaches the centers of the upper and bottom surfaces.

The heating furnace 430 is a spherical space (globularity) formed inside the test box 400, and a temperature inside the heating furnace 430 may be adjusted.

The central point of the spherical space forming the heating furnace 430 coincides with the central point of the test box 400, which is a rectangular parallelepiped. That is, the heating furnace 430 is formed at the center of the inside of the test box 400.

In one embodiment of the present disclosure, the sample valve 200 may include a valve body 210 and a safety opening and closing unit 220. Hydrogen fuel is injected into the valve body 210 connected to the fuel supply pipe 130. Here, the hydrogen fuel is pressurized to 700 MPa, and is injected into the valve body 210.

The safety opening and closing unit 220 opens the valve body 210 when the temperature of gas inside the valve body 210 reaches 110 degrees Celsius. Alternatively, the safety opening and closing unit 220 intermittently discharges the hydrogen fuel in the valve body 210 to the outside.

The temperature inside the heating furnace 430 may be set to 600 degrees Celsius, and the sample valve 200 accommodated in the heating furnace 430 may be tested for the performance thereof in discharging and depressurizing the hydrogen fuel under a predetermined temperature.

A temperature serving as a reference at which the safety opening and closing unit 220 opens the valve body 210 may be set to a predetermined temperature, such as 110 degrees Celsius, 100 degrees Celsius, or 120 degrees Celsius, depending on the embodiment to which the present disclosure is applied, and the temperature inside the heating furnace 430 may also be set to a temperature different from 600 degrees Celsius depending on the embodiment to which the present disclosure is applied.

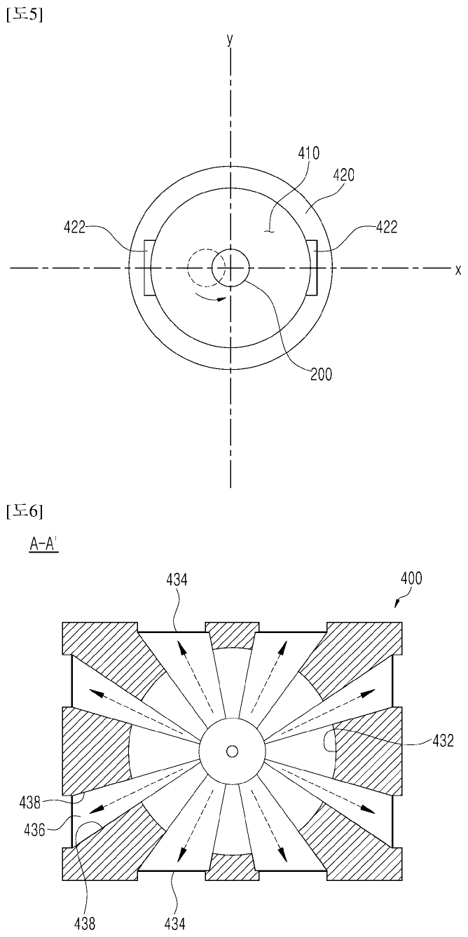

FIG. 5 is a view showing the inlet 410 and the entry end 420 of the test box 400 in the heating test apparatus according to one embodiment of the present disclosure.

As shown in FIG. 5, precision detection sensors 422 and/or a collision detection sensor 424 may be provided on the entry end 420 or the upper surface of the test box 400.

The precision detection sensor 422 detects the position of the sample valve 200 and transmits the detected position of the sample valve 200 to the controller 500, and the controller 500 operates the benchtop module 300 based on the positions of the inlet 410 and the entry end 420 calculated through position information of the sample valve 200 and position information of the test box 400, and thereby, the test box 400 is moved so that the sample valve 200 may be accommodated in the heating furnace 430 of the test box 400.

Here, the collision detection sensor 424 may be provided on the entry end 420 or the upper surface of the test box 400 adjacent to the inlet 410.

The collision detection sensor 424 may detect an object in a predetermined area, and may measure a distance from the detected object in real time. That is, the collision detection sensor 24 detects a distance between the test box 400 and the sample valve 200 in real time and transmits the detected information to the controller 500 as the test box 400 moves and approaches the sample valve 200. The controller 500 controls the sample valve 200 and the test box 400 not to contact each other based on information acquired through the collision detection sensor 424, thereby allowing the sample valve 200 to be accommodated in the heating furnace 430.

Further, the controller 500 measures the position of the sample valve 422 or the fuel supply pipe 130 passing through the entry end 420 through the precision detection sensors 422 or the collision detection sensor 424, and thus adjusts the sample valve 200 to be located at the exact center of the inside of the heating furnace 430, as shown in this figure.

FIG. 6 is a cross-sectional view taken along line A-A′ of FIG. 4.

As shown in FIG. 6, the heating furnace 430, which is a space formed in the test box 400, is a spherical space (globularity), and may be maintained at a predetermined temperature through the controller 500.

Reinforcement parts 432 and the fracture parts 434 are formed on the inner wall of the heating furnace 430, i.e., the inner surface of the test box 400. The reinforcement parts 432 have a wall which is relatively thicker than other areas of the heating furnace 430, and increase the strength of the test box 400 forming the heating furnace 430 to make the test box 400 more robust. As shown in FIG. 6, a plurality of reinforcement parts 432 is provided such that the horizontal cross-section of the heating furnace 430 is point symmetrical with respect to the central point of the heating furnace 430.

The fracture part 434 is provided between the reinforcement part 432 and the reinforcement part 432, and the fracture part 434 includes a fracture wall 436 and expansion walls 438.

The fracture wall 436 is a wall that breaks when a predetermined pressure is applied thereto. The fracture wall 436 is formed to have a constant thickness, and a virtual straight line drawn from the central point of the heating furnace 430 toward the fracture wall 436 has an acute angle, which is smaller than a right angle, at a point where it intersects the fracture wall 436.

A point at which destruction begins at the fracture wall 436 if an explosion occurs in the heating furnace 430 may be specified.

Specifically, the width of the fracture wall 436 becomes maximum at the middle part of the test box 400. In addition, one side of the fracture wall 436 at the middle part of the test box 400, which is located relatively far away from the central point of the heating furnace 430 and is tilted at a predetermined angle (acute angle) with the direction of force applied when the pressure inside the heating furnace 430 is raised, becomes structurally weak.

Therefore, when the internal pressure of the heating furnace 430 becomes greater than a predetermined value, the fracture wall 434 is destroyed starting from one side of the middle part thereof, which is structurally weak. Then, the fracture surface of the fracture wall 434 gradually expands from the point where destruction began to surrounding areas. Such a structure has the effect of primarily attenuating impact caused by explosion of hydrogen fuel, minimizing flying debris, and gradually lowering the pressure inside the heating furnace 430.

The fracture wall 436 is located between the reinforcement part 432 and the reinforcement part 432 inside the heating furnace 430. Since the reinforcement parts 432 are formed of a wall thicker than the fracture wall 436, the fracture wall 436 between the reinforcement part 432 and the reinforcement part 432 is formed as a long groove formed long in the vertical direction.

Accordingly, the expansion walls 438, which are both walls of the groove entering toward the fracture wall 436 between the reinforcement part 432 and the reinforcement part 432 inside the heating furnace 430, may be formed so that virtual straight lines drawn radially from the central point of the heating furnace 430 pass through the surfaces of the expansion walls 438. Therefore, force in a direction extending radially from the central point of the inside of the heating furnace 430 does not interfere with the expansion walls 438.

That is, the surface angle of each expansion wall 438 is determined so that each expansion wall 438 coincides with a virtual straight line drawn radially from one point located at the center of the heating furnace 430 inside the heating furnace 430.

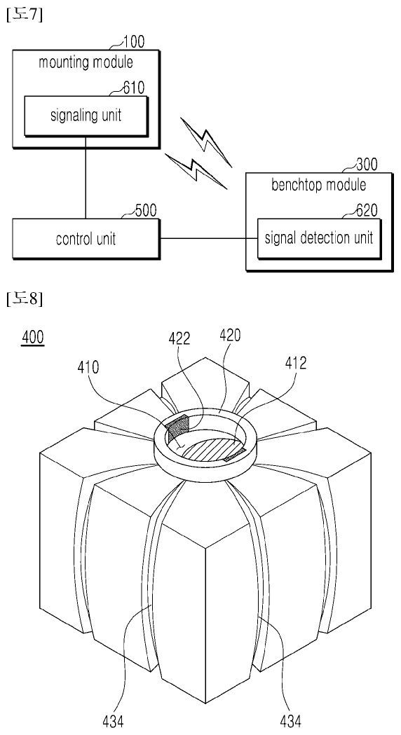

FIG. 7 is a block diagram briefly showing some components provided in the explosion-proof compartment 40 in the heating test apparatus according to one embodiment of the present disclosure.

As shown in FIG. 7, the sample-holding module 100 and the benchtop module 300 are installed in the explosion-proof compartment 40. The sample-holding module 100 may further include a signaling unit 610, and the benchtop module 300 may further include a signal detection unit 620.

This is an example, and the signaling unit 610 and the signal detection unit 620 may be paired, and may be installed separately in the sample-holding module 100 and the benchtop module 300, respectively.

The signaling unit 610 and the signal detection unit 620, which are macroscopic sensors, may detect positions of the sample valve 200 and the test box 400 and transmit the detected positions to the controller 500 during a process of aligning the positions of the sample valve 200 and the test box 400 through the precision detection sensors 422 and/or the collision detection sensor 424, thereby allowing the controller 500 to adjust the benchtop module 300 to perform primary alignment.

After performed the primary alignment through information obtained by transmitting and searching the positions of the counterparts by the signaling unit 610 and the signal detection unit 620, the controller 500 may further perform secondary alignment to finely adjust the position of the test box 400 based on position information measured more precisely through the precision detection sensors 422 and/or the collision detection sensor 424.

FIG. 8 is a perspective view of a test box 400 in a heating test apparatus according to another embodiment of the present disclosure.

As shown in FIG. 8, in another embodiment of the present disclosure, the test box 400 may include a shutoff door 412 at an inlet 410. The shutoff door 412 may be provided below an entry end 420, and may be provided to open or close the inlet 410.

The shutoff door 412 is open through the controller 500 only if a distance between a sample valve 200 and the inlet 410 detected through the precision detection sensors 422 and/or the collision detection sensor 424 is less than or equal to a predetermined distance.

While the embodiments of the present disclosure have been described with reference to the accompanying drawings, the description is an example, and the present disclosure described as above is not limited by the embodiments and the accompanying drawings. It should be apparent to those skilled in the art that various substitutions, changes and modifications which are not exemplified herein but are still within the spirit and scope of the present disclosure may be made. In addition, even if functions or effects depending on a configuration were not explicitly described while describing one embodiment of the present disclosure, it is to be understood that even predictable effects due to the corresponding configuration should be recognized.

1. An explosion-proof environment benchtop heating test apparatus for performance testing of a safety valve, which tests performance of a sample valve configured to open upon reaching a predetermined temperature, comprising:
an explosion-proof chamber having an explosion-proof compartment as a space opened or closed through an explosion-proof door, formed therein;
a sample-holding module provided in the explosion-proof compartment and configured to hold the sample valve in air and supply gas of a predetermined pressure to the sample valve;
a bench top module provided in the explosion-proof compartment and configured to move a test box having a heating furnace therein; and
a controller configured to control the benchtop module based on positions of the sample valve and the test box so that the sample valve is accommodated in the heating furnace.

2. The explosion-proof environment benchtop heating test apparatus according to claim 1, wherein the sample valve comprises:
a valve body connected to the sample-holding module; and
a safety opening and closing unit provided on one side of the vehicle body and opened at a temperature of 110 degrees Celsius,
wherein the gas supplied to the sample valve through the sample-holding module is hydrogen (H₂) pressurized to 700 MPa; and
an internal pressure of the heating furnace is heated to 600 degrees Celsius.

3. The explosion-proof environment benchtop heating test apparatus according to claim 1, wherein the sample-holding module comprises:
a holding frame installed on a ceiling of the explosion-proof compartment to have a predetermined path;
a sample tower coupled to the holding frame, moved along the holding frame, and configured such that the sample valve is coupled to the sample tower; and
a fuel supply pipe configured to supply hydrogen fuel of a predetermined pressure to the sample valve.

4. The explosion-proof environment benchtop heating test apparatus according to claim 1, wherein the benchtop-module comprises:
guide rails installed on a bottom of the explosion-proof compartment to have a predetermined path;
a movable body coupled to the guide rails to be moved along the guide rails and configured such that the test box is coupled to an upper part of the movable body; and
an elevating unit configured to raise and lower the test box from the movable body.

5. The explosion-proof environment benchtop heating test apparatus according to claim 4, wherein the test box comprises:
an inlet connected to the heating furnace provided inside the test box and formed at a center of an upper surface of the test box;
an entry end formed along an open perimeter of the inlet; and
a precision detection sensor provided at the entry end and configured to detect the position of the sample valve located outside or inside the heating furnace and transmit a position of the entry end and the position of the sample valve to the controller.

6. The explosion-proof environment benchtop heating test apparatus according to claim 5, wherein the test box further comprises a shutoff door configured to open or close the inlet,
wherein the controller opens the shutoff door when the sample valve approaches the inlet by a predetermined distance or less.

7. The explosion-proof environment benchtop heating test apparatus according to claim 1, wherein the heating furnace is provided as a spherical space formed inside the test box.

8. The explosion-proof environment benchtop heating test apparatus according to claim 7, wherein the test box comprises:
a plurality of reinforcement parts formed at parts of a side wall of the heating furnace, configured to protrude inward to increase strength of the test box, and provided such that a horizontal cross-section of the heating furnace is point symmetrical with respect to a central point of the heating furnace; and
fracture parts formed between the reinforcement parts on an inner surface of the heating furnace and configured to be at least partially destroyed when the heating furnace reaches a predetermined pressure.

9. The explosion-proof environment benchtop heating test apparatus according to claim 8, wherein each of the fracture parts comprises:
a plurality of expansion walls formed along virtual straight lines drawn radially from the central point of the heating furnace; and
a fracture wall formed of a thinner material than the reinforcement parts between the expansion walls and torn and destroyed when the heating furnace reaches the predetermined pressure.
